(19) United States
(12) Patent Application Publication
(10) Pub. No.: US 2026/0106930 A1
(43) Pub. Date: Apr. 16, 2026

(54) MANAGING GROUP MESSAGING FOR A TEMPORARY SUBGROUP

(71) Applicant: Motorola Mobility LLC, Chicago, IL (US)

(72) Inventors: Amit Kumar Agrawal, Bangalore (IN); Panduranga Reddy Pailla, Bangalore (IN); Vijayprakash Idlur, Bangalore (IN)

(73) Assignee: Motorola Mobility LLC, Chicago, IL (US)

(21) Appl. No.: 18/915,067

(22) Filed: Oct. 14, 2024

(51) Int. Cl. H04M 1/72436; G06Q 10/1093; H04W 4/12

(52) U.S. Cl. CPC H04M 1/72436; G06Q 10/1093; H04W 4/12

(57) ABSTRACT

In aspects of managing group messaging for a temporary subgroup, a mobile device implements a subgroup messaging coordinator to determine associations between users within a communication group based on data, such as familial and/or workplace relationships between the users. The subgroup messaging coordinator determines upcoming events related to the users within the communication group, and based on the associations between the users, the subgroup messaging coordinator determines a temporary communication subgroup of one or more of the users in the communication group. The one or more users of the temporary communication subgroup are determined by the subgroup messaging coordinator based on the associations between the users to omit or exclude users of the communication group that may not be interested in the subgroup and/or may not have a role, or for whom the event is planned as a surprise event.

### BACKGROUND

Electronic mobile devices, such as smartphones, are often used for chat messaging communications between users. Such devices can support chat messaging groups which include two or more users. Communications sent to a chat messaging group are communicated to each device within the group. This enables a user to communicate with one or more other users in a convenient manner. However, in some situations, communications within a chat messaging group may not be of interest to one or more of the users within the group. For example, a discussion within a chat messaging group may shift to topics that are unrelated to particular users in the group. Although users may be able to leave the group, this can be detrimental to attempts to coordinate the group, e.g., for gathering the group members to a particular location. Additionally, other users within the group may notice that particular users have left group, which can lead to unintended social consequences. Further, such groups can sometimes lead to miscommunications in situations in which users unintentionally send a communication to the entire group when the communication was intended for single individual or a different group. This can lead to confusion and potential distribution of information to users within the group that were not intended to have access to the communicated information.

### BRIEF DESCRIPTION OF THE DRAWINGS

Implementations of the techniques for managing group messaging for a temporary subgroup are described with reference to the following Figures. The same numbers may be used throughout to reference like features and components shown in the Figures.

FIG. 1 illustrates an example system for managing group messaging for a temporary subgroup in accordance with one or more implementations as described herein.

FIGS. 2-5 further illustrate an example of managing group messaging for a temporary subgroup in accordance with one or more implementations as described herein.

FIG. 6 illustrates an example group member associations graph for managing group messaging for a temporary subgroup in accordance with one or more implementations of the techniques described herein.

FIGS. 7-8 illustrate example methods for managing group messaging for a temporary subgroup in accordance with one or more implementations of the techniques described herein.

FIG. 9 illustrates various components of an example device that may be used to implement the techniques for managing group messaging for a temporary subgroup as described herein.

### DETAILED DESCRIPTION

Implementations of the techniques for managing group messaging for a temporary subgroup may be implemented as described herein. A mobile device, such as any type of a wireless device, media device, mobile phone, flip phone, client device, tablet, computing, communication, entertainment, gaming, media playback, and/or any other type of computing, consumer, and/or electronic device, or a system of any combination of such devices, may be configured to perform techniques for managing group messaging for a temporary subgroup, as described herein. In one or more implementations, a mobile device includes a subgroup messaging coordinator, which can be used to implement aspects of the techniques described herein.

Mobile devices such as smartphones include a variety of functionality relating to communication with other individuals. For example, smartphones are able to support telephonic communications between individuals as well as chat messaging communications between individuals. In some situations, communications may be between a group of individuals, with each individual associated with a particular mobile device. For example, a first individual, a second individual, and third individual may have a first mobile device, a second mobile device, and third mobile device, respectively. The mobile devices may communicate electronically with each other via a wired or wireless connection in order to support chat messaging communications between each of the devices. Such mobile devices may support a creation of a digital or virtual communication group that includes each of the individuals. Chat messages communicated to the group using an individual mobile device are communicated to the mobile device of each individual within the group. As an example, the first individual may input a chat message to a communication group including the second individual and the third individual, and the chat message is communicated from the first mobile device to each of the second mobile device and the third mobile device using the wired or wireless connection.

However, in some situations, communication groups can include a large number of individuals (e.g., ten individuals, twenty individuals, etc.) and messages communicated to the group may not be relevant to every individual in the group. Further, in some situations, users may desire to communicate chat messages to multiple particular users within a group without communicating the chat messages to every user within the group. Conventional systems attempt to address these issues by supporting the creation of multiple communication groups, where each communication group is maintained separately from other communication groups. However, navigating and identifying the users in each communication group can be difficult and time consuming for users. For example, in a situation in which a communication group includes thirty individuals, a user may desire to communicate information via a chat message to twenty-five of the individuals while refraining from communicating the information to the other five individuals. However, in order to do so, the user has to manually create a second communication group separate from the main communication group and manually adds each of the twenty-five individuals to the second communication group.

This approach can increase a likelihood of confusion of individuals in the second communication group and may lead to undesired miscommunications. For example, users within the second communication group may mistake the second group for the main group and may unintentionally communicate information to the individuals in the main group that is not intended for those individuals. Further, each group may persist indefinitely and cause confusion for a user attempting to discern which group to use for communicating a chat message at a future time.

The techniques described herein address these issues and support managing group messaging for a temporary subgroup. As described herein, a mobile device includes a subgroup messaging coordinator configured to automatically determine associations between users within a communication group based on data, such as familial and/or workplace relationships between the users, locations of the users, etc. The subgroup messaging coordinator is further configured to detect upcoming events related to the users within the communication group, such as birthdays, anniversaries, and occasions that may benefit from group communication for planning of social gatherings, meetings, parties, etc. Based on detection of an upcoming event and the associations between the users, the subgroup messaging coordinator determines a set of users within the communication group that are relevant to planning of the event and automatically generates a prompt at one or more mobile devices associated with the users in the set for generation of a temporary communication subgroup. Responsive to input to the prompt, the temporary communication subgroup is formed and includes the set of users. The set of users is determined by the subgroup messaging coordinator based on the associations between the users to omit or exclude users of the communication group that may not be interested in the subgroup and/or may not have a role in an event, or for someone the event is planned as a surprise. For example, some users may be omitted or excluded for whom the event is being planned as a surprise such, as excluding one person to plan his or her birthday, or excluding a couple to plan their anniversary.

As one example, the subgroup messaging coordinator may detect that an individual within the communication group has an upcoming birthday. The birthday is considered an event by the subgroup messaging coordinator for the purpose of generating a temporary communication subgroup associated with the birthday. The subgroup messaging coordinator further determines a set of individuals from the communication group to be included in the subgroup, where the individuals have a familial or other association to the individual associated with the birthday. The set of individuals is determined by the subgroup messaging coordinator to omit the individual having the birthday so as to not alert the individual of the formation of the subgroup. Thus, individuals within the subgroup are able to more easily communicate with each other to plan a meeting or party for the individual associated with the birthday without that individual having knowledge that the planning is occurring. The prompt to form the subgroup is communicated to the mobile device of each person within the set of individuals automatically, and responsive to input to the prompt by one or more of the individuals, the subgroup is formed. The subgroup messaging coordinator may further automatically terminate the subgroup responsive to detection that one or more termination conditions have been satisfied. The termination conditions may be based on, for example, a time duration following the date of the birthday, a time duration between communications in the subgroup, and/or a number of users in the subgroup.

In this way, the described techniques facilitate automatic management of communications using subgroups in a manner that is convenient and intuitive for users while reducing a likelihood of unintentional communication of information to individuals that are not intended to receive such information. In some implementations, the subgroup messaging coordinator may communicate a prompt to merge a subgroup with another subgroup if the subgroup messaging coordinator determines that there is overlap between the events associated with each subgroup. Thus, the subgroup messaging coordinator reduces occurrences of miscommunications, reduces instances of irrelevant, redundant, or duplicated communication groups, and facilitates communication in a manner that reduces a likelihood of unintentional exposure of event planning information to individuals associated with events.

While features and concepts of the described techniques for managing group messaging for a temporary subgroup is implemented in any number of different devices, systems, environments, and/or configurations, implementations of the techniques for managing group messaging for a temporary subgroup are described in the context of the following example devices, systems, and methods.

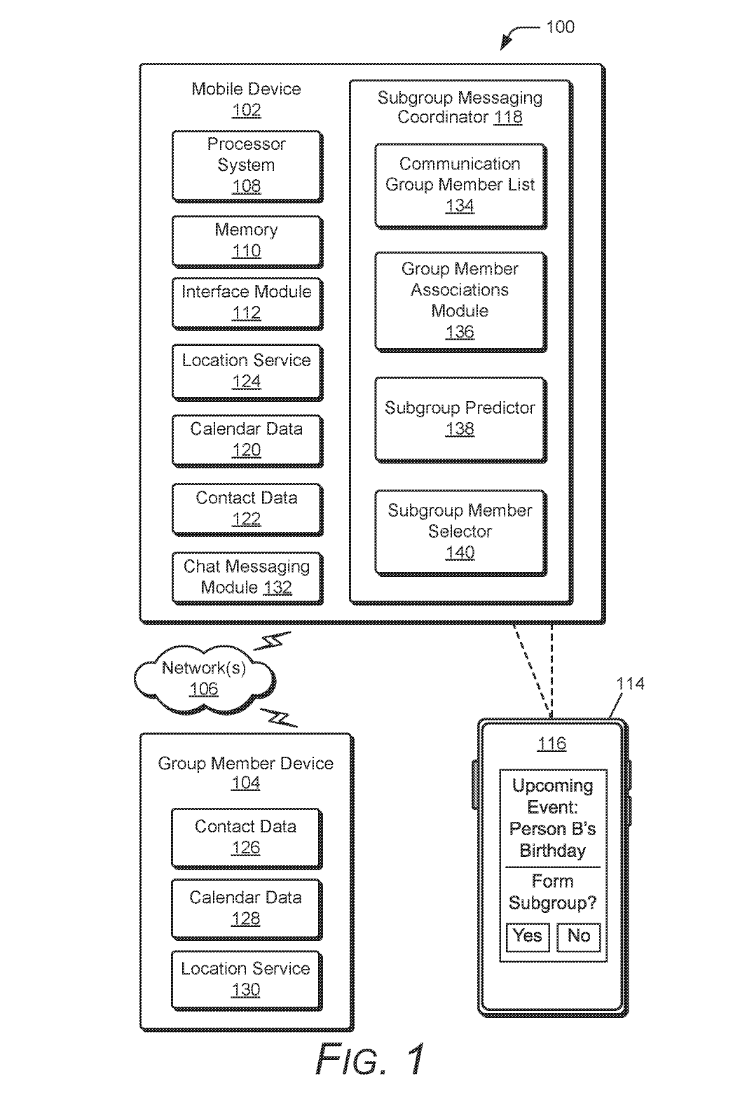

FIG. 1 illustrates an example system 100 for managing group messaging for a temporary subgroup, as described herein. The system 100 includes a mobile device 102, a group member device 104, and a communication network 106. Examples of the mobile device 102 include at least one of any type of a wireless device, mobile device, mobile phone, flip phone, client device, companion device, tablet, computing device, communication device, entertainment device, gaming device, media playback device, and/or any other type of computing, consumer, and/or electronic device.

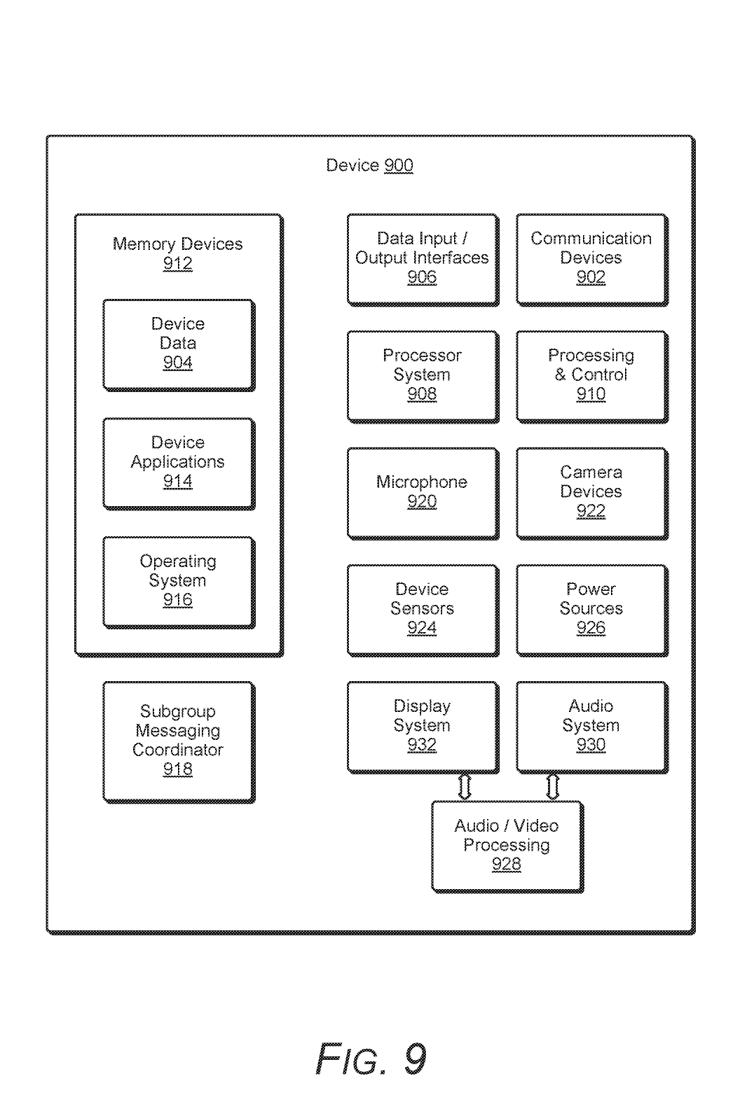

The mobile device 102 can be implemented with various components, such as a processor system 108 and a memory 110, as well as any number and combination of different components as further described with reference to the example device shown in FIG. 9. In implementations, the mobile device 102 includes various radios for wireless communication with other devices. For example, the system and devices can include a Bluetooth (BT) and/or Bluetooth Low Energy (BLE) transceiver, as well as a near field communication (NFC) transceiver. In some cases, the system and devices includes at least one of a WiFi radio, a cellular radio, a global positioning satellite (GPS) radio, or any available type of device communication interface.

In some implementations, the devices, applications, modules, servers, and/or services described herein communicate via the communication network 106, such as for data communication with the mobile device 102. The communication network 106 includes a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider.

The mobile device 102 includes various functionality that enables the device to implement different aspects of managing group messaging for a temporary subgroup, as described herein. In one or more examples, an interface module 112 represents functionality (e.g., logic and/or hardware) enabling the mobile device 102 to interconnect and interface with other devices and/or networks, such as the communication network 106. For example, the interface module 112 enables wireless and/or wired connectivity of the mobile device 102.

The mobile device 102 can include and implement various device applications, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen 114 of the mobile device 102. Generally, an application user interface, or any other type of video, image, graphic, and the like is digital image content that is displayable on the display screen 114 of the mobile device 102. As one example, FIG. 1 depicts the display screen 114 displaying user interface 116.

In the example system 100 for managing group messaging for a temporary subgroup, the mobile device 102 implements a subgroup messaging coordinator 118 (e.g., as a device application). As shown in this example, the subgroup messaging coordinator 118 represents functionality (e.g., logic, software, and/or hardware) enabling aspects of the described techniques for managing group messaging for a temporary subgroup. The subgroup messaging coordinator 118 can be implemented as computer instructions stored on computer-readable storage media and can be executed by a processor system of the mobile device 102. Alternatively, or in addition, the subgroup messaging coordinator 118 can be implemented at least partially in hardware of the device.

In one or more implementations, the subgroup messaging coordinator 118 includes independent processing, memory, and/or logic components functioning as a computing and/or electronic device integrated with the mobile device 102. Alternatively, or in addition, the subgroup messaging coordinator 118 can be implemented in software, in hardware, or as a combination of software and hardware components. In this example, the subgroup messaging coordinator 118 is implemented as a software application or module, such as executable software instructions (e.g., computer-executable instructions) that are executable with a processor system of the mobile device 102 to implement the techniques and features described herein. As a software application or module, the subgroup messaging coordinator 118 can be stored on computer-readable storage memory (e.g., memory of a device), or in any other suitable memory device or electronic data storage implemented with the controller. Alternatively or in addition, the subgroup messaging coordinator 118 is implemented in firmware and/or at least partially in computer hardware. For example, at least part of the subgroup messaging coordinator 118 is executable by a computer processor, and/or at least part of the content manager is implemented in logic circuitry.

In this example system 100, the subgroup messaging coordinator 118 receives various data describing upcoming events and associations between individuals and generates a temporary communication subgroup accordingly. For example, the data available to the subgroup messaging coordinator 118 may include calendar data 120 and contact data 122 associated with the mobile device 102. The calendar data 120 indicates entries in a calendar maintained in the memory 110. The calendar entries may include, for example, dates and times associated with birthdays, anniversaries, workplace meetings, appointments, etc. In some implementations, the calendar data 120 and/or the contact data 122 may be stored locally on the mobile device 102, e.g., within memory 110. In some implementations, the calendar data 120 and/or the contact data 122 may be stored remotely, e.g., “in the cloud,” and accessed by the mobile device 102 via the communication network 106.

In some implementations, the subgroup messaging coordinator 118 receives location data that indicates a geographical location of the mobile device 102 via a location service 124. The location service 124 may track a location of the mobile device 102 via communication with a global positioning system over the communication network 106, for example. The location data may be provided to the subgroup messaging coordinator 118 to determine, for example, a proximity of the mobile device 102 to other devices within a communication group.

One example device that may be in a communication group with the mobile device 102 is depicted by FIG. 1 as the group member device 104. In some implementations, the group member device 104 may include components similar to, or the same as, the mobile device 102. For example, the group member device 104 may include a subgroup messaging coordinator similar to, or the same as, the subgroup messaging coordinator 118. The group member device 104 additionally includes data associated with the group member device 104 that may be communicated to the subgroup messaging coordinator 118 of the mobile device 102 in some implementations. In particular, the group member device 104 may include respective contact data 126, calendar data 128, and location data from the location service 130. The contact data 126 may indicate names, addresses, telephone numbers, and other information associated with individuals, and the calendar data 128 may indicate birthdays, anniversaries, work meetings, appointments, etc. (e.g., as calendar entries in a digital calendar maintained by the group member device 104).

The various data may be stored locally to the group member device 104 (e.g., within a memory of the group member device 104) and/or stored remotely to the group member device 104 (e.g., in the cloud) and accessed via the communication network 106. The group member device 104 may provide permission for the subgroup messaging coordinator 118 to access the respective contact data 126, the calendar data 128, and the location data associated with the group member device 104, e.g., responsive to user input to the group member device 104. The group member device 104 is depicted as one example device in electronic communication with the mobile device 102, and it should be appreciated that a plurality of group member devices may similarly communicate with the mobile device 102 (e.g., ten devices, twenty devices, etc.).

The mobile device 102 additionally includes a chat messaging module 132 configured to support individual or group chat messaging communications with other devices, such as the group member device 104. For example, the chat messaging module 132 may facilitate generation of communication groups and sorting of chat message communications to the associated communication groups as conversation threads. Each user within a communication group is associated with a respective device (e.g., group member device 104), such that communication chat messages to the users in a communication group communicates the chat messages to the respective devices of the users.

The subgroup messaging coordinator 118 may communicate electronically with the chat messaging module 132 for maintaining a communication group member list 134. The communication group member list 134 is data indicating group members (referred to herein as users and individuals) included within one or more communication groups supported by the chat messaging module 132. The communication group member list 134 may be stored in memory 110 in some implementations.

The subgroup messaging coordinator 118 further includes a group member associations module 136. The group member associations module 136 may be utilized by the subgroup messaging coordinator 118 to determine associations between the users identified by the communication group member list 134. The associations between the users that can be identified using the group member associations module 136 may include, for example, familial relationships, workplace relationships, similar locations of users, similar ages of users, similar genders of users, similar interests of users, frequency of communications between users (e.g., telephonic communications, chat messaging communications, etc.), and/or other types of associations. As one example, the group member associations module 136 may identify members within a communication group that belong to a same family, such as parents, siblings, cousins, etc. In this example, the group member associations module 136 may identify the members using the contact data 122 and/or other data available to the subgroup messaging coordinator 118, such as social media accounts of the users, emails of the users, etc. The contact data 122 may include, for example, names of individuals, phone numbers associated with individuals, a frequency of communication with individuals using the mobile device 102, mailing addresses of the individuals, and/or other identifying information associated with individuals.

In some implementations, the group member associations module 136 may determine associations between the group members based on chat message communications among the group members that are accessible to the mobile device 102. For example, the chat messaging module 132 may maintain chat messaging conversations that have occurred between the user of the mobile device 102 and users of other devices, such as the group member device 104. Based on content of the conversations, the group member associations module 136 may identify various associations between the group members. As one example, an individual within a communication group may communicate a chat message to other members within the group that includes the individual as a sibling of another individual within the group. The group member associations module 136 may identify the individuals as siblings based on the chat message content.

The group member associations module 136 may be implemented using any one or more of a variety of different public or proprietary machine learning models trained to identify the associations between users as described above. Machine learning models refer to a computer representation that can be tuned (e.g., trained) based on inputs to approximate unknown functions. In particular, machine learning models can utilize algorithms to learn from, and make predictions on, known data by analyzing the known data to learn to generate outputs that reflect patterns and attributes of the known data. For instance, a machine learning model included by the group member associations module 136 can include decision trees, support vector machines, linear regression, logistic regression, Bayesian networks, random forest learning, dimensionality reduction algorithms, boosting algorithms, artificial neural networks, deep learning, and so forth.

The subgroup messaging coordinator 118 further includes a subgroup predictor 138. The subgroup predictor 138 is configured to determine events which may be used as a basis for forming temporary communication subgroups according to the techniques described herein. The subgroup predictor 138 may determine upcoming events that may be of interest to individuals included in a communication group, such as birthdays of the individuals, anniversaries of the individuals, work-related meetings or gatherings that may involve the individuals, and so forth. The events may be determined by the subgroup predictor 138 based on the data available to the subgroup messaging coordinator 118, such as the calendar data 120, contact data 122, location data, data of devices of other individuals in the communication group (e.g., contact data 126, calendar data 128, etc. of group member device 104), social media data, chat messaging communication data, etc. As one example, contact data 122 may indicate a birthday of an individual in a communication group, where the group includes the user of the mobile device 102. The subgroup predictor 138 may identify the birthday as an upcoming event, and as a result, the subgroup messaging coordinator 118 may automatically perform operations such as generating a prompt at one or more devices of users within the group for generation of a temporary communication subgroup. The generation of the prompt may be based a subgroup formation condition such as detection by the subgroup predictor 138 that a duration between a current time and a time of the event is less than a threshold duration (e.g., one month before the event, one week before the event, etc.).

The subgroup messaging coordinator 118 further includes a subgroup member selector 140. The subgroup member selector 140 is configured to determine a set of users from a communication group for inclusion by a temporary communication subgroup. The set of users may be determined based on the associations between the users (as determined by the group member associations module 136) and the event associated with the subgroup (as determined by subgroup predictor 138). The subgroup member selector 140 may further identify users of the group to exclude or omit from the subgroup based on the associations between the users and/or the event associated with the subgroup. For example, as described above, it may be undesirable to include an individual in a subgroup associated with a birthday event if the birthday is for that individual (so as to avoid providing the individual with knowledge of the subgroup for planning activities related to the birthday).

The subgroup predictor 138 and/or the subgroup member selector 140 may be implemented using any one or more of a variety of different public or proprietary machine learning models trained to associate users with events. For instance, a machine learning model included by the subgroup member selector 140 can include decision trees, support vector machines, linear regression, logistic regression, Bayesian networks, random forest learning, dimensionality reduction algorithms, boosting algorithms, artificial neural networks, deep learning, and so forth.

As an example operation of the mobile device 102, a communication group including several individuals is formed via the chat messaging module 132. Various chat message communications are exchanged between the individuals using the group. The subgroup predictor 138 detects an upcoming anniversary for two individuals in the group based on associations between the individuals and/or content of the chat message communications. As a result, the subgroup messaging coordinator 118 utilizes the associations between the group members determined by the group member connection module 136 to determine a set of users from the group to include in a subgroup via the subgroup member selector 140. Based on the associations between the users and the determination that the event is the anniversary for the two individuals, the subgroup member selector 140 omits the two individuals from the set of users to include in the subgroup. Additionally, the subgroup member selector 140 may omit users in the group that do not have associations to the two individuals from the set of users to include in the subgroup.

The subgroup messaging coordinator 118 communicates a prompt to the users in the set. Responsive to input applied to the prompt at one of the user devices confirming that generation of the subgroup is desired, the subgroup messaging coordinator 118 generates the subgroup and includes the set of users in the subgroup. Access to the subgroup is provided at any of the group member devices corresponding to a user in the set. For example, the subgroup messaging coordinator 118 may command a user interface at each device to display an icon for accessing the subgroup and communicating chat messages to the users in the subgroup. Chat messages as described herein may include a mix of textual content (e.g., text input via an application, transcriptions of speech, etc.), image content (e.g., animated and/or static digital images), video content (e.g., linked and/or embedded video content that may, or may not, include audio data), and/or audio content (e.g., recorded speech, music, etc.). In one or more implementations, chat messaging may include and/or support several formats, including text, video, audio, images, memes, GIFs, emojis etc.

While the subgroup is active, if the subgroup messaging coordinator 118 detects that one or more subgroup termination conditions have been satisfied, the subgroup messaging coordinator 118 may automatically terminate (e.g., dissolve) the subgroup or combine the subgroup with another subgroup. For example, following completion of the event (e.g., after the anniversary has occurred), the subgroup messaging coordinator 118 may detect that a duration following the event has exceeded a threshold duration (e.g., one day, two days, one week, etc.). The subgroup messaging coordinator 118 may thus determine that a termination condition has been satisfied and automatically terminate the subgroup.

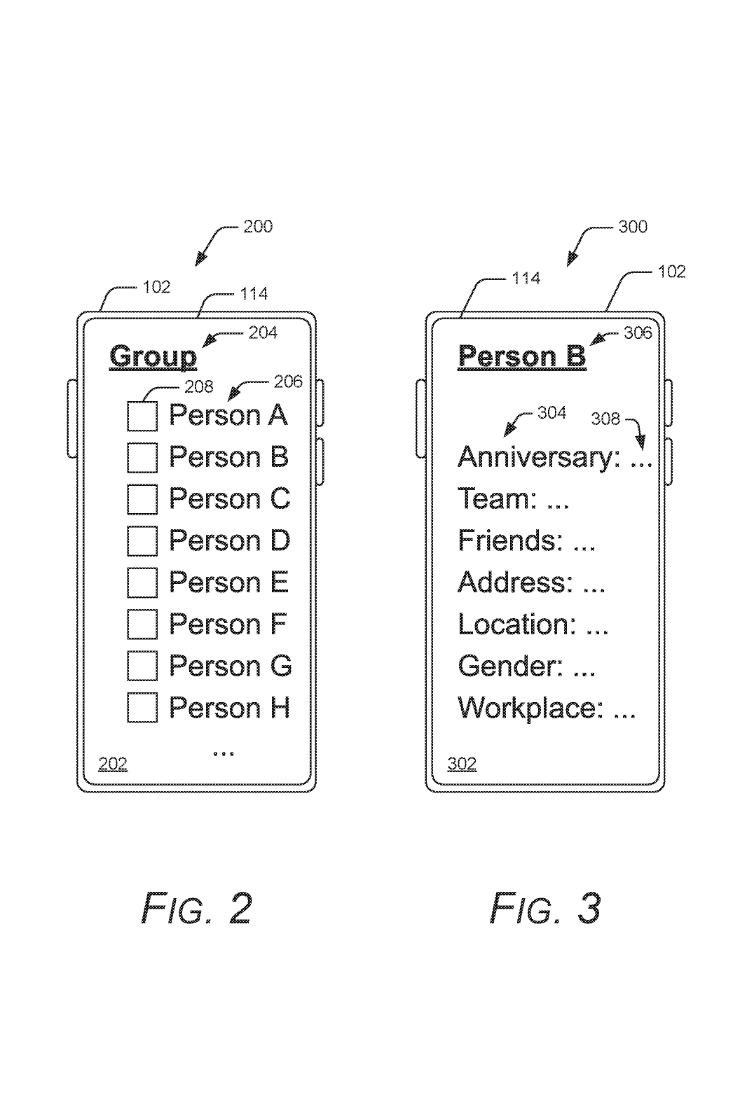

FIG. 2 illustrates an example 200 of managing group messaging for a temporary subgroup, as described herein. In this example 200, the mobile device 102 is depicted showing a menu 202 of a graphical user interface (GUI) for a communication group. A title 204 of the communication group is displayed in the menu 202, and a plurality of individuals included in the communication group are displayed via a list 206. In the implementation shown, the list entry for each individual is accompanied by an image or icon (e.g., a thumbnail) representative of that individual. For example, the individual “Person A” in the list 206 is represented by an icon 208. Although in the example shown in the list 206 displays eight individuals, it should be appreciated that the list 206 may include any different number of individuals without departing from the scope of the described techniques. Additionally, each individual is associated with a respective device (such as group member device 104) such that inputting a chat message to the mobile device 102 for communication of the chat message to the communication group results in communication of the chat message to the respective devices associated with the individuals in the list 206.

FIG. 3 illustrates an example 300 of managing group messaging for a temporary subgroup, as described herein. In this example 300, the mobile device 102 is depicted showing a menu 302 of the GUI. In the menu 302, contact data 304 associated with an individual in the communication group (in this case, “Person B,” as indicated by an identifier 306) is shown. Each type of contact data may include one or more entries (e.g., populated data fields), indicated generally by arrow 308. Although the contact data associated with “Person B” is depicted, it should be appreciated that the mobile device 102 may maintain contact data for each individual in the communication group (e.g., in memory 110).

FIG. 4 illustrates an example 400 of managing group messaging for a temporary subgroup, as described herein. In this example 400, the mobile device 102 is depicted showing a menu 402 of the GUI. In the menu 402, a user interface prompt 404 is displayed. The user interface prompt 404 may be displayed by the GUI responsive to a determination by the subgroup predictor 138 that a subgroup formation condition has been satisfied. The subgroup formation condition may include, for example, an identification of an upcoming event associated with one or more individuals in the communication group. The user interface prompt 404 is shown including a “Yes” panel 406 and a “No” panel 408. During conditions in which input is applied to the panel 406, the subgroup messaging coordinator 118 forms the temporary communication subgroup and includes a set of users in the subgroup as described above. However, during conditions in which input is applied to the panel 408, the subgroup messaging coordinator 118 does not immediately form the subgroup. However, as described above, for each individual in the set of users, the subgroup messaging coordinator 118 communicates the user interface prompt 404 to a respective device of the individual. If input is applied at the panel 406 at any of the devices, the subgroup messaging coordinator 118 may form the subgroup. The applied input may include, for example, selecting one of the panels by touching a touchscreen displaying the GUI (e.g., in configurations in which the display screen 114 is a touchscreen) or otherwise selecting one of the panels.

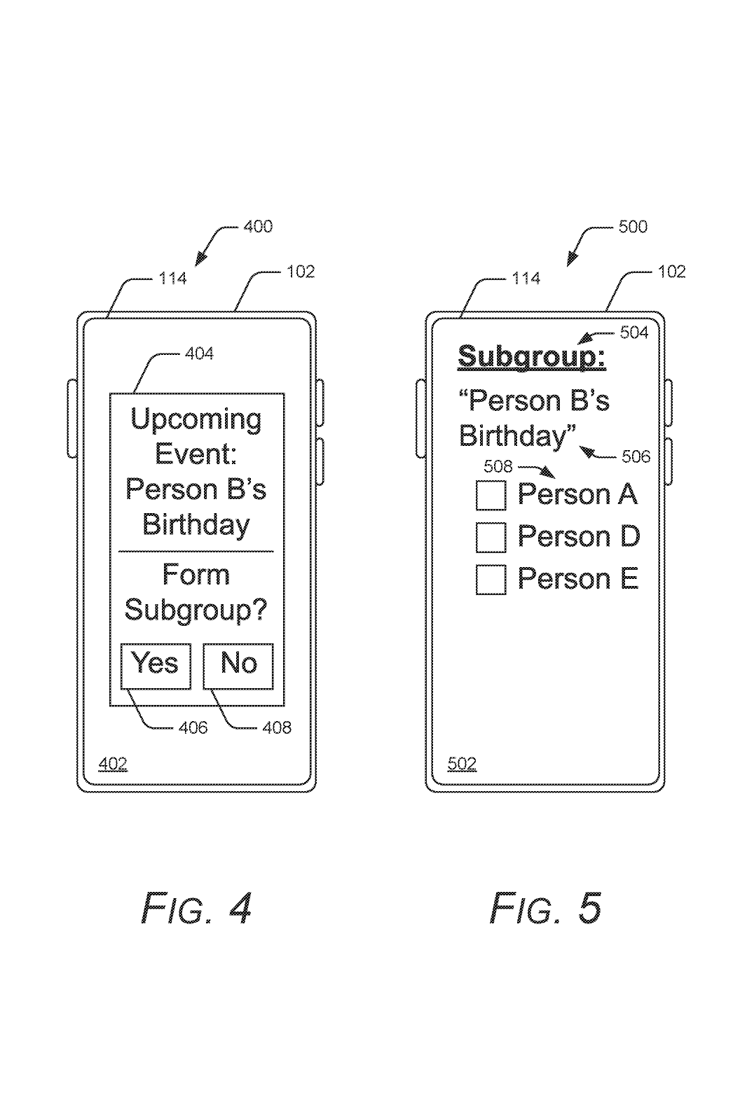

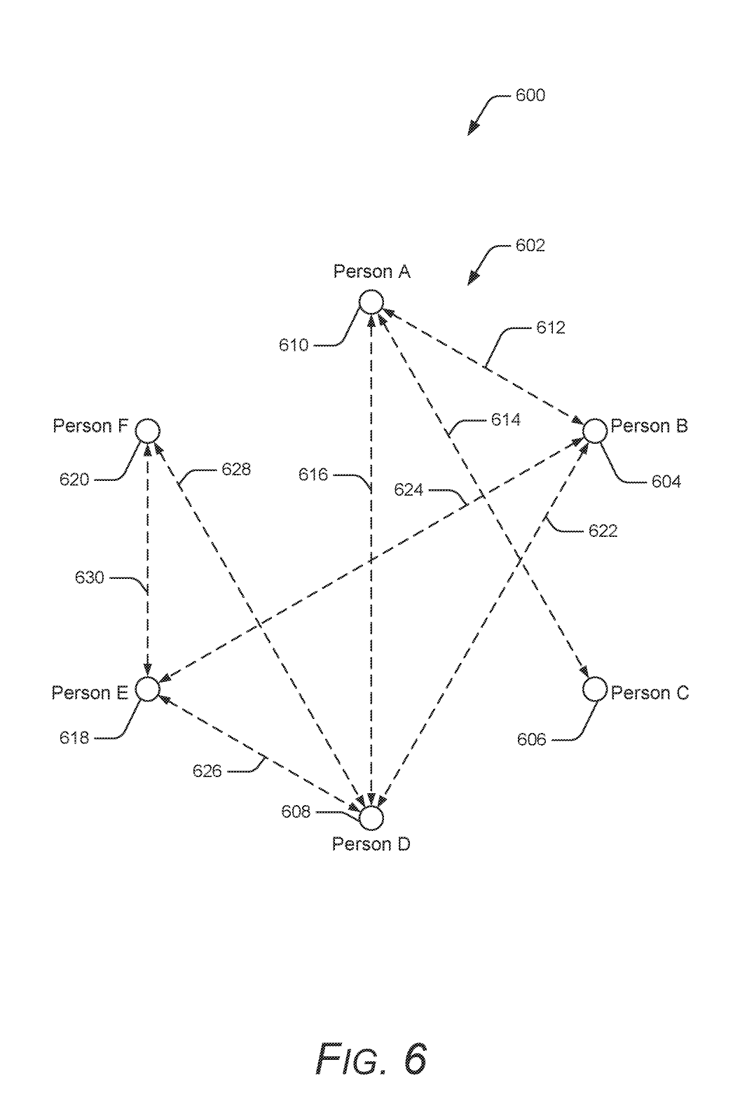

FIG. 5 illustrates an example 500 of managing group messaging for a temporary subgroup, as described herein. In this example 500, the mobile device 102 is depicted showing a menu 502. In the menu 502, a temporary communication subgroup is depicted. A title 504 of the temporary communication subgroup is displayed at an upper end of the menu 502, along with a description 506 of the event associated with generation of the subgroup. A plurality of individuals included in the temporary communication subgroup are displayed via a list 508. As the event is “Person B’s Birthday” in the depicted example, “Person B” is not included in the subgroup to avoid notifying “Person B” of communications related to the event. Each individual is associated with a respective device (such as group member device 104) such that inputting a chat message to the mobile device 102 for communication of the chat message to the temporary communication subgroup results in communication of the chat message to the respective devices associated with the individuals in the list 508.

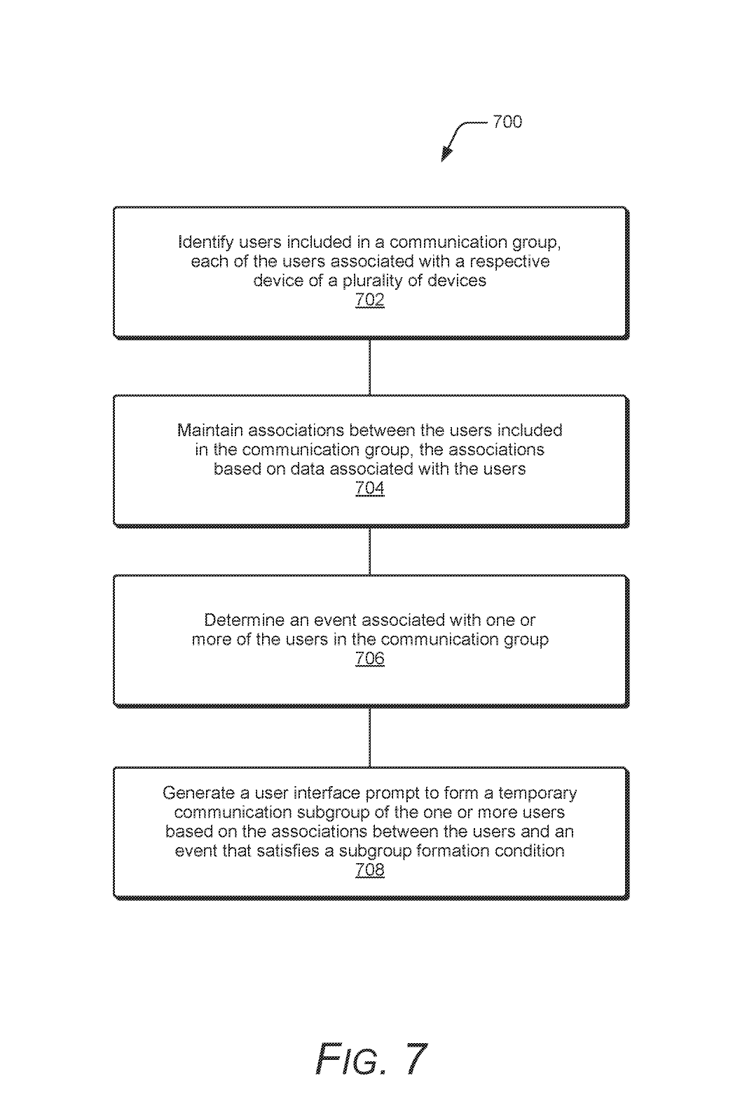

FIG. 6 illustrates example 600 of a group member associations graph 602 for managing group messaging for a temporary subgroup, as described herein. In this example 600, the graph 602 depicts associations between individuals included in the communication group of FIG. 2 as broken lines. The associations are determined via the group member associations module 136 as described above (e.g., based on data associated with the individuals, such as chat messaging communications, familial relationships, etc.).

In the example shown, each individual does not have an association with every other individual. Instead, some individuals have associations with each other, while other individuals do not have associations with each other. In particular, “Person A” has associations with “Person B” represented by node 604, “Person C” represented by node 606, and “Person D” represented by node 608. The associations between node 610 and node 604 are represented by line 612, the associations between node 610 and node 606 are represented by line 614, and the associations between node 610 and node 608 are represented by line 616. However, “Person A” does not have associations with “Person E” or “Person F.” As such, no lines extend between node 610 representing “Person A” and node 618 or node 620 representing “Person E” and “Person F,” respectively. Further, “Person B” has associations with “Person D” and “Person E” as represented by line 622 and line 624, respectively. “Person D” has associations with “Person E” and “Person F” as represented by line 626 and line 628, respectively. “Person E” has associations with “Person F” as represented by line 630.

In the depicted example, because “Person A,” “Person D,” and “Person E” have associations with “Person B,” “Person A,” “Person D,” and “Person E” are included in the subgroup shown by FIG. 5. However, because the other individuals represented in the graph 602 do not have associations with “Person B,” the other individuals are not included in the subgroup. Additionally, because the event is for the birthday of “Person B,” “Person B” is not included in the subgroup. The determination of which individuals are included in the subgroup is performed by the subgroup member selector 140 as described above.

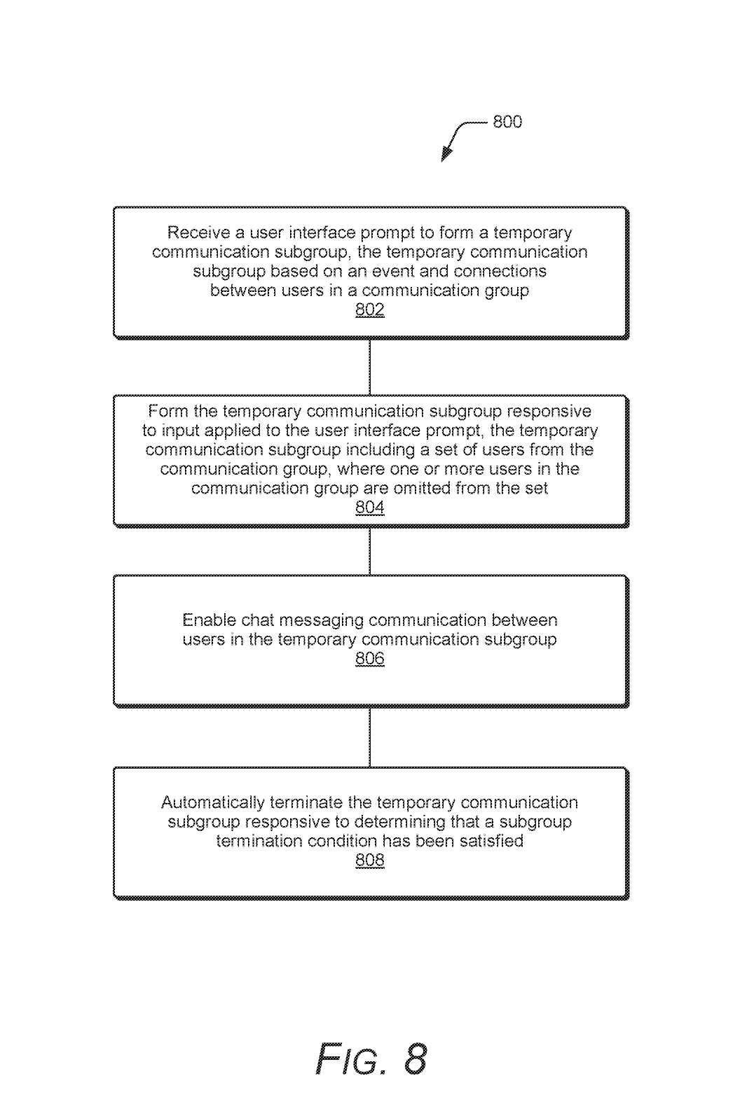

Example methods 700 and 800 are described with reference to respective FIG. 7 and FIG. 8 in accordance with one or more implementations of managing group messaging for a temporary subgroup, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 7 illustrates example method 700 for managing group messaging for a temporary subgroup. The order in which the method is described is not intended to be construed as a limitation, and any number or combination of the described method operations may be performed in any order to perform a method, or an alternate method.

At 702, users included in a communication group are identified, where each of the users is associated with a respective device of a plurality of devices. For example, the users are identified by the subgroup messaging coordinator 118 using the communication group member list 134 and may be the users depicted in FIG. 2.

At 704, associations between the users included in the communication group are maintained in a mobile device, each of the users associated with a respective device of a plurality of devices and the associations based on data associated with the users. For example, the associations are determined via the group member associations module 136 based on the contact data 122, the contact data 126, chat messaging communications between the users, users within a threshold range of each other as indicated by location data, etc.

At 706, an event associated with one or more of the users in the communication group is determined. For example, the subgroup predictor 138 determines one or more upcoming events associated with users in the communication group, where the determination of the events may be based on the contact data 122, chat messaging communications between the users, and/or other data.

At 708, a user interface prompt is generated to form a temporary communication subgroup of the one or more users based on the associations between the users and the event that satisfies a subgroup formation condition. For example, the user interface prompt 404 is generated and displayed via the menu 402, and input applied to panel 406 results in formation of the subgroup by the subgroup messaging coordinator 118.

FIG. 8 illustrates example method 800 for managing group messaging for a temporary subgroup. The order in which the method is described is not intended to be construed as a limitation, and any number or combination of the described method operations may be performed in any order to perform a method, or an alternate method.

At 802, a user interface prompt is received to form a temporary communication subgroup, the temporary communication subgroup based on an event and associations between users in a communication group. For example, the user prompt may be the user interface prompt 404.

At 804, the temporary communication subgroup is formed responsive to input applied to the user interface prompt, the temporary communication subgroup including a set of users from the communication group, where one or more users in the communication group are omitted from the set. For example, input is applied at panel 406 of the user interface prompt 404, resulting in formation of the temporary communication subgroup by subgroup messaging coordinator 118. The subgroup messaging coordinator 118 determines users in list 508 to include in the temporary communication subgroup using the subgroup member selector 140 and omits at least “Person B” from the subgroup.

At 806, chat messaging communication between users in the temporary communication subgroup is enabled. For example, users in the list 508 may input chat messaging communications for the subgroup via the graphical user interface, and the chat messages are communicated to the respective device of each individual in the subgroup.

At 808, the temporary communication subgroup is automatically terminated responsive to determining that a subgroup termination condition has been satisfied. For example, the subgroup termination condition may be a determination that a duration immediately following the event is greater than a first threshold duration. As another example, the subgroup termination condition may be a duration between sequential communications within the temporary communication subgroup being greater than a threshold duration (e.g., two days, three days, etc.). As another example, the subgroup termination condition may be a number of users in the subgroup being less than a threshold number (e.g., in situations in which one or more users remove themselves from the subgroup).

FIG. 9 illustrates various components of an example device 900, which can implement aspects of the techniques and features for managing group messaging for a temporary subgroup, as described herein. The example device 900 may be implemented as any of the devices described with reference to the previous FIGS. 1-8, such as any type of a wireless device, mobile device, mobile phone, flip phone, client device, companion device, display device, tablet, computing, communication, entertainment, gaming, media playback, and/or any other type of computing, consumer, and/or electronic device. For example, the mobile device 102 described with reference to FIGS. 1-8 may be implemented as the example device 900.

The example device 900 can include various, different communication devices 902 that enable wired and/or wireless communication of device data 904 with other devices. The device data 904 can include any of the various device data and content that is generated, processed, determined, received, stored, and/or communicated from one computing device to another. Generally, the device data 904 can include any form of audio, video, image, graphics, and/or electronic data that is generated by applications executing on a device. The communication devices 902 can also include transceivers for cellular phone communication and/or for any type of network data communication.

The example device 900 can also include various, different types of data input / output (I/O) interfaces 906, such as data network interfaces that provide connection and/or communication links between the devices, data networks, and other devices. The data I/O interfaces 906 may be used to couple the device to any type of components, peripherals, and/or accessory devices, such as a computer input device that may be integrated with the example device 900. The I/O interfaces 906 may also include data input ports via which any type of data, information, media content, communications, messages, and/or inputs may be received, such as user inputs to the device, as well as any type of audio, video, image, graphics, and/or electronic data received from any content and/or data source.

The example device 900 includes a processor system 908 of one or more processors (e.g., any of microprocessors, controllers, and the like) and/or a processor and memory system implemented as a system-on-chip (SoC) that processes computer-executable instructions. The processor system 908 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 910. The example device 900 may also include any type of a system bus or other data and command transfer system that couples the various components within the device. A system bus can include any one or combination of different bus structures and architectures, as well as control and data lines.

The example device 900 also includes memory and/or memory devices 912 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 912 include volatile memory and non-volatile memory, fixed and removable media devices, and any suitable memory device or electronic data storage that maintains data for computing device access. The memory devices 912 can include various implementations of random-access memory (RAM), read-only memory (ROM), flash memory, and other types of storage media in various memory device configurations. The example device 900 may also include a mass storage media device.

The memory devices 912 (e.g., as computer-readable storage memory) provide data storage mechanisms, such as to store the device data 904, other types of information and/or electronic data, and various device applications 914 (e.g., software applications and/or modules). For example, an operating system 916 may be maintained as software instructions with a memory device 912 and executed by the processor system 908 as a software application. The device applications 914 may also include a device manager, such as any form of a control application, software application, signal-processing and control module, code that is specific to a particular device, a hardware abstraction layer for a particular device, and so on.

In this example, the device 900 includes a subgroup messaging coordinator 918 that implements various aspects of the described features and techniques described herein. The subgroup messaging coordinator 918 may be implemented with hardware components and/or in software as one of the device applications 914, such as when the example device 900 is implemented as the mobile device 102 described with reference to FIGS. 1-8. An example of the subgroup messaging coordinator 918 is the subgroup messaging coordinator 118 implemented by the mobile device 102, such as a software application and/or as hardware components in the mobile device. In implementations, the subgroup messaging coordinator 918 may include independent processing, memory, and logic components as a computing and/or electronic device integrated with the example device 900.

The example device 900 can also include a microphone 920 (e.g., to capture an audio recording of a user) and/or camera devices 922 (e.g., to capture video images of the user during a call), as well as device sensors 924, such as may be implemented as components of an inertial measurement unit (IMU). The device sensors 924 may be implemented with various sensors, such as a gyroscope, an accelerometer, and/or other types of motion sensors to sense motion of the device. The device sensors 924 can generate sensor data vectors having three-dimensional parameters (e.g., rotational vectors in x, y, and z-axis coordinates) indicating location, position, acceleration, rotational speed, and/or orientation of the device. The example device 900 can also include one or more power sources 926, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 900 can also include an audio and/or video processing system 928 that generates audio data for an audio system 930 and/or generates display data for a display system 932. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 900. Alternatively, the audio system and/or the display system are external, peripheral components to the example device.

Although implementations for managing group messaging for a temporary subgroup have been described in language specific to features and/or methods, the appended claims are not necessarily limited to the specific features or methods described. Rather, the specific features and methods are disclosed as example implementations for managing group messaging for a temporary subgroup, and other equivalent features and methods are intended to be within the scope of the appended claims. Further, various different examples are described, and it is to be appreciated that each described example may be implemented independently or in connection with one or more other described examples.

In some aspects, the techniques described herein relate to a mobile device, including: at least one memory; and at least one processor coupled with the at least one memory and configured to implement a subgroup messaging coordinator that causes the mobile device to: identify users included in a communication group, each of the users associated with a respective device of a plurality of devices; determine associations between the users in the communication group based on data associated with the users; determine an event associated with one or more of the users in the communication group; and generate a user interface prompt to form a temporary communication subgroup of the one or more users based on the associations between the users and the event that satisfies a subgroup formation condition.

In some aspects, the techniques described herein relate to a mobile device, wherein the data indicates familial relationships of one or more of the users.

In some aspects, the techniques described herein relate to a mobile device, wherein the data indicates a frequency of chat messaging communications between the mobile device and at least one of the plurality of devices.

In some aspects, the techniques described herein relate to a mobile device, wherein the data indicates calendar entry information of at least one of the plurality of devices.

In some aspects, the techniques described herein relate to a mobile device, wherein the subgroup messaging coordinator includes a machine learning model maintained in the at least one memory, the machine learning model trained to determine the associations between the users using the data.

In some aspects, the techniques described herein relate to a mobile device, wherein the data indicates chat messaging communications between the mobile device and the plurality of devices, and the subgroup messaging coordinator includes a machine learning model trained to identify the event from the chat messaging communications using the data.

In some aspects, the techniques described herein relate to a mobile device, wherein the subgroup messaging coordinator is configured to cause the mobile device to form the temporary communication subgroup of the one or more users responsive to input applied to the user interface prompt at the mobile device or one of the plurality of devices.

In some aspects, the techniques described herein relate to a mobile device, wherein the subgroup messaging coordinator is configured to omit one or more of the users in the communication group from the temporary communication subgroup based on the event.

In some aspects, the techniques described herein relate to a mobile device, wherein the subgroup formation condition is a time duration between a current time and a time of the event being less than a threshold duration.

In some aspects, the techniques described herein relate to a mobile device, wherein the communication group is a chat message communication group of the mobile device, and the subgroup messaging coordinator is configured to communicate chat messaging to respective devices of the plurality of devices of the one or more users of the temporary communication subgroup.

In some aspects, the techniques described herein relate to a mobile device, wherein the subgroup messaging coordinator is configured to cause the mobile device to automatically terminate the temporary communication subgroup responsive to determining that a subgroup termination condition has been satisfied.

In some aspects, the techniques described herein relate to a mobile device, wherein the subgroup termination condition includes at least one of a time duration after the event being greater than a threshold duration, the time duration between sequential communications within the temporary communication subgroup being greater than the threshold duration, or a number of the one or more users in the temporary communication subgroup being less than a threshold number.

In some aspects, the techniques described herein relate to a method, including: maintaining associations between users included in a communication group in a mobile device, each of the users associated with a respective device of a plurality of devices and the associations based on data associated with the users; determining, by the mobile device, an event associated with one or more of the users in the communication group; and generating a user interface prompt to form a temporary communication subgroup of the one or more users based on the associations between the users and the event that satisfies a subgroup formation condition.

In some aspects, the techniques described herein relate to a method, further including determining the temporary communication subgroup of the users based on the event and the associations using a machine learning model; and forming the temporary communication subgroup of the one or more users responsive to input applied to the user interface prompt at the mobile device.

In some aspects, the techniques described herein relate to a method, further including omitting one or more of the users in the communication group from the temporary communication subgroup based on the event.

In some aspects, the techniques described herein relate to a method, further including automatically terminating the temporary communication subgroup responsive to determining that a subgroup termination condition has been satisfied.

In some aspects, the techniques described herein relate to a system, including: a memory to maintain a communication group member list and data associated with users indicated in the communication group member list, the data identifying associations between respective devices of a plurality of devices associated with the users indicated in the communication group member list; and a subgroup messaging coordinator configured to: determine an event associated with one or more of the users in the communication group member list; identify a subgroup formation condition based at least in part on the event; and generate a user interface prompt to form a temporary communication subgroup of the one or more users based on the associations and the event.

In some aspects, the techniques described herein relate to a system, wherein the subgroup messaging coordinator is configured to form the temporary communication subgroup of the one or more users responsive to input applied to the user interface prompt.

In some aspects, the techniques described herein relate to a system, wherein the subgroup messaging coordinator is configured to omit one or more of the users indicted in the communication group members list from the temporary communication subgroup based on the event.

In some aspects, the techniques described herein relate to a system, wherein the subgroup messaging coordinator is configured to automatically terminate the temporary communication subgroup responsive to determining that a subgroup termination condition has been satisfied, the subgroup termination condition including at least one of: a time duration after the event being greater than a threshold duration; the time duration between sequential communications within the temporary communication subgroup being greater than the threshold duration; or a number of the one or more users in the temporary communication subgroup being less than a threshold number.

1. A mobile device, comprising:
at least one memory; and
at least one processor coupled with the at least one memory and configured to implement a subgroup messaging coordinator that causes the mobile device to:
identify users included in a communication group, each of the users associated with a respective device of a plurality of devices;
determine associations between the users in the communication group based on data associated with the users;
determine an event associated with one or more of the users in the communication group; and
generate a user interface prompt to form a temporary communication subgroup of the one or more users based on the associations between the users and the event that satisfies a subgroup formation condition.

2. The mobile device of claim 1, wherein the data indicates familial relationships of one or more of the users.

3. The mobile device of claim 1, wherein the data indicates a frequency of chat messaging communications between the mobile device and at least one of the plurality of devices.

4. The mobile device of claim 1, wherein the data indicates calendar entry information of at least one of the plurality of devices.

5. The mobile device of claim 1, wherein the subgroup messaging coordinator includes a machine learning model maintained in the at least one memory, the machine learning model trained to determine the associations between the users using the data.

6. The mobile device of claim 1, wherein the data indicates chat messaging communications between the mobile device and the plurality of devices, and the subgroup messaging coordinator includes a machine learning model trained to identify the event from the chat messaging communications using the data.

7. The mobile device of claim 1, wherein the subgroup messaging coordinator is configured to cause the mobile device to form the temporary communication subgroup of the one or more users responsive to input applied to the user interface prompt at the mobile device or one of the plurality of devices.

8. The mobile device of claim 7, wherein the subgroup messaging coordinator is configured to omit one or more of the users in the communication group from the temporary communication subgroup based on the event.

9. The mobile device of claim 1, wherein the subgroup formation condition is a time duration between a current time and a time of the event being less than a threshold duration.

10. The mobile device of claim 1, wherein the communication group is a chat message communication group of the mobile device, and the subgroup messaging coordinator is configured to communicate chat messaging to respective devices of the plurality of devices of the one or more users of the temporary communication subgroup.

11. The mobile device of claim 1, wherein the subgroup messaging coordinator is configured to cause the mobile device to automatically terminate the temporary communication subgroup responsive to determining that a subgroup termination condition has been satisfied.

12. The mobile device of claim 11, wherein the subgroup termination condition includes at least one of a time duration after the event being greater than a threshold duration, the time duration between sequential communications within the temporary communication subgroup being greater than the threshold duration, or a number of the one or more users in the temporary communication subgroup being less than a threshold number.

13. A method, comprising:
maintaining associations between users included in a communication group in a mobile device, each of the users associated with a respective device of a plurality of devices and the associations based on data associated with the users;
determining, by the mobile device, an event associated with one or more of the users in the communication group; and
generating a user interface prompt to form a temporary communication subgroup of the one or more users based on the associations between the users and the event that satisfies a subgroup formation condition.

14. The method of claim 13, further comprising:
determining the temporary communication subgroup of the users based on the event and the associations using a machine learning model; and
forming the temporary communication subgroup of the one or more users responsive to input applied to the user interface prompt at the mobile device.

15. The method of claim 14, further comprising:
omitting one or more of the users in the communication group from the temporary communication subgroup based on the event.

16. The method of claim 15, further comprising:
automatically terminating the temporary communication subgroup responsive to determining that a subgroup termination condition has been satisfied.

17. A system, comprising:
a memory to maintain a communication group member list and data associated with users indicated in the communication group member list, the data identifying associations between respective devices of a plurality of devices associated with the users indicated in the communication group member list; and
a subgroup messaging coordinator configured to:
determine an event associated with one or more of the users in the communication group member list;
identify a subgroup formation condition based at least in part on the event; and
generate a user interface prompt to form a temporary communication subgroup of the one or more users based on the associations and the event.

18. The system of claim 17, wherein the subgroup messaging coordinator is configured to form the temporary communication subgroup of the one or more users responsive to input applied to the user interface prompt.

19. The system of claim 17, wherein the subgroup messaging coordinator is configured to omit one or more of the users indicted in the communication group members list from the temporary communication subgroup based on the event.

20. The system of claim 17, wherein the subgroup messaging coordinator is configured to:
automatically terminate the temporary communication subgroup responsive to determining that a subgroup termination condition has been satisfied, the subgroup termination condition including at least one of:
a time duration after the event being greater than a threshold duration;
the time duration between sequential communications within the temporary communication subgroup being greater than the threshold duration; or
a number of the one or more users in the temporary communication subgroup being less than a threshold number.
